(19) United States
(12) Patent Application Publication
(10) Pub. No.: US 2008/0137906 A1
(43) Pub. Date: Jun. 12, 2008

(54) Smoke Detecting Method And Device

(75) Inventors: Shen-Kuen Chang, Hsinchu (TW); Chung-Hsien Lu, Hsinchu (TW); Hao-Ting Zhao, Hsinchu (TW); Shih-Hua Chang, Hsinchu (TW); Yu-Ren Hsu, Hsinchu (TW)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Industrial Technology Research Institute, Hsinchu (TW)

(21) Appl. No.: 11/760,657

(22) Filed: Jun. 8, 2007

(30) Foreign Application Priority Data
Dec. 12, 2006 (TW) 095146544

(51) Int. Cl. G06K 9/00; G08B 17/12

(52) U.S. Cl. 382/100; 340/628; 348/61; 382/190

(57) ABSTRACT

A smoke detecting method is provided. The smoke detecting method includes steps of (a) capturing a video segment for a object and a background; (b) analyzing if an image of the object is moving; (c) analyzing a chrominance variance of the moving object with a corresponding background; (d) analyzing at least one of an edge blur of the image of the background and a flickering frequency of the moving object with its corresponding background; (e) comparing analyzed results obtained from the steps (b)-(d) to a smoke feature; and (f) determining if the moving object is a smoke.

### FIELD OF THE INVENTION

The present invention relates to a smoke detecting method and device, and more particular to a smoke detecting method and device using the image analysis.

### BACKGROUND OF THE INVENTION

In most fires, the smoke is usually generated at the beginning, followed by the occurrence of flames. Even in some fires, burning of some substances generates the smoke only. Therefore, the smoke detecting is a very important object to the fire preventing and the fire rescuing. Using the smoke detecting system can report at the beginning of a fire so that the early fire fighting may be proceeded for decreasing the loss of fortune and lives.

The conventional smoke detecting devices, such as the photoelectric smoke detector and the air sampling smoke detector, use the physical properties resulting from the increasing smoke particles as the basis of fire detecting. The photoelectric smoke detector emits the light. Once there exist smoke particles in the air, the light is scattered and the brightness is changed. The photoelectric smoke detector detects the variation of the brightness to determine if there is a fire. This detecting method is limited by the light emitting, so the detecting range thereof is restricted. Therefore, the smoke detecting in the large areas by the photoelectric smoke detector is not good enough. The air sampling smoke detector collects the air sample in the detecting area and analyzes the elements of the collected air to determine if there is a fire. For collecting the air sample, the air sampling smoke detector must be equipped with a duct system for facilitating the detection. Besides, the sensors of the air sampling smoke detector are also very expensive.

Accordingly, the conventional smoke detecting devices have the shortcomings as follows: 1) it is hard to detect the smoke in the high and large-area buildings, such as the factories, the stadiums and the shopping malls, thereby missing the early rescuing time; 2) the accuracy thereof is too low, thereby causing too many fake alarms; and 3) a large number of the sensors, conducts and controlling systems needs to be installed, thereby raising the cost.

Therefore, for improving the accuracy of the smoke detecting device and saving the cost, recently, the visual smoke detecting device has been developed which identifies if there is any object whose features meet the fire smoke by using the original monitoring system in the building. Once the smoke detecting device determines the object as the fire smoke, an alarm will be generated.

In order to overcome the drawbacks in the prior art, an improved smoke detecting method and device are provided. The particular design in the present invention not only solves the problems described above, but also is easy to be implemented. Thus, the present invention has the utility for the industry.

### SUMMARY OF THE INVENTION

In accordance with one aspect of the present invention, a smoke detecting method is provided. The smoke detecting method comprises steps of (a) capturing a video segment for an object and a background; (b) analyzing if an image of the object is moving; (c) analyzing a chrominance variance of the moving object with its corresponding background; (d) analyzing at least one of an edge blur of the image of the background and a flickering frequency of the image of the moving object with its corresponding background; (e) comparing analyzed results obtained from the steps (b)-(d) to a smoke feature; and (f) determining if the moving object is a smoke.

Preferably, the smoke detecting method further comprises (g) sending out an alarm when the moving object is determined as the smoke.

In accordance with another aspect of the present invention, a smoke detecting device is provided. The smoke detecting device comprises an image capturing device capturing a video segment having a first image for an object and a second image for a background; a determining device coupled to the image capturing device, analyzing if the first image is moving, analyzing a chrominance variance of the first and the second images and at least one of an edge blur of the second image and a flickering frequency of the first and the second images; and determining if the object is a smoke by comparing analyzed results of the first and the second images to a smoke feature.

Preferably, the smoke detecting device further comprises an alarming device coupled to the determining device for generating an alarm when the object is determined as the smoke.

Preferably, the image capturing device is one of a web camera and a cable camera.

Preferably, the determining device is one of a computer and a digital signal processing chip.

Preferably, the chrominance variance is a chrominance-decreased extent affected by the smoke.

Preferably, the edge blur reflects how an edge of the background is affected by the smoke.

In accordance with a further aspect of the present invention, a smoke detecting device is provided. The smoke detecting device comprises an image capturing device capturing a first image for an object and a second image for a background; a first analyzing device coupled to the image capturing device and analyzing at least one of a flickering frequency of the first and the second images and an edge blur of the second image; and a comparing device coupled to the first analyzing device and comparing a first analyzed result obtained from the first analyzing device to a smoke feature.

Preferably, the smoke detecting device further comprises a second analyzing device coupled to the image capturing device and analyzing if the first image is moving; and a third analyzing device coupled to the image capturing device and analyzing a chrominance variance of the first and the second images, wherein the comparing device is further coupled to the image capturing device and compares the first analyzed result obtained from the first analyzing device and second analyzed results obtained from the second and the third analyzing devices to the smoke feature.

Preferably, the smoke detecting device further comprises an alarming device coupled to the comparing device and generating an alarm when a comparison of the analyzed results to the smoke feature shows that the object is a smoke.

Preferably, the image capturing device is one of a web camera and a cable camera.

Preferably, the first analyzing device is one of a computer and a digital signal processing chip.

Preferably, each of the second and third analyzing devices is one of a computer and a digital signal processing chip.

Preferably, the chrominance variance is a chrominance-decreased extent of the second image affected by the smoke.

Preferably, the flickering frequency is a brightness variation of the first image varying with time.

Preferably, the edge blur of the second image is affected by the smoke.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1A is a diagram showing the structure of the smoke detecting device according to a first preferred embodiment of the present invention;

FIG. 1B is a diagram showing the structure of the smoke detecting device according to a second preferred embodiment of the present invention;

FIG. 1C is a diagram showing the structure of the smoke detecting device according to a third preferred embodiment of the present invention; and

FIG. 2 is a flow chart of the smoke detecting method in the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed. For overcoming the frequent errors produced by the conventional fire detection which causes the fake alarms and delays the rescuing action, the present invention provides a novel smoke detecting method and device. In the smoke detecting method and device of the present invention, the smoke features detecting uses several analyzing units to analyze the features of the object in the video for collecting the data of the object. Moreover, the comparing device includes a database to store the thresholds of each feature for comparing the analyzed data thereto. The thresholds of each feature are the enormous experimental and statistic calculated features data of the fire smoke. Such analyzing and comparing processes can identify the smoke more accurately for determining the fire.

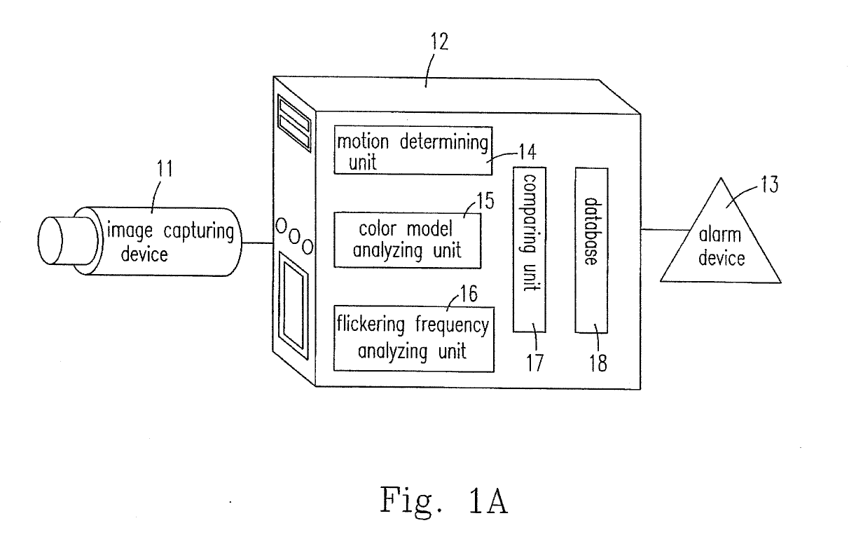

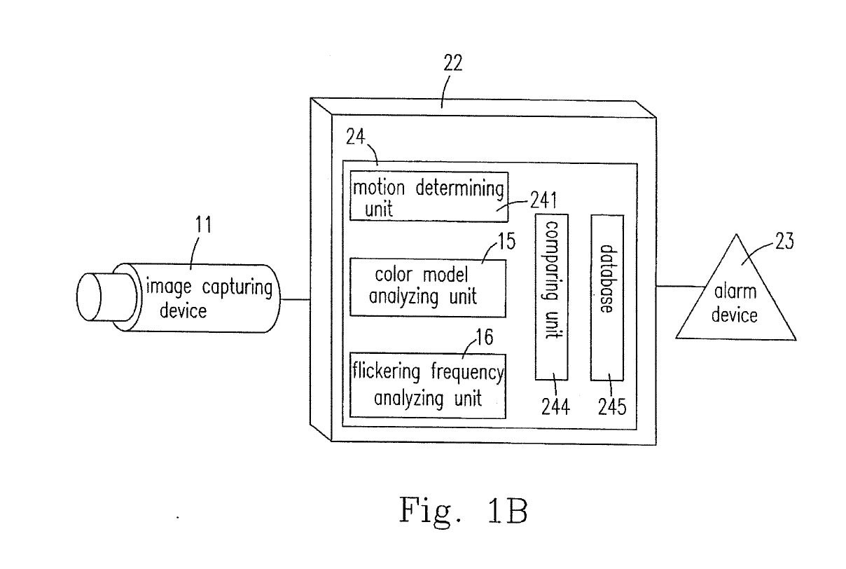

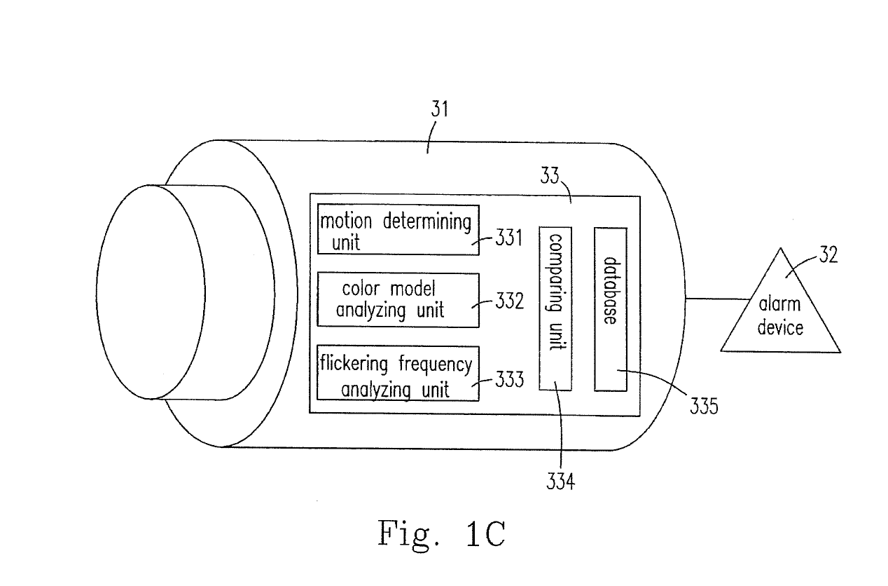

Please refer to FIG. 1A, which shows the structure of the smoke detecting device according to a first preferred embodiment of the present invention. The smoke detecting device includes an image capturing device 11, a computer 12 and an alarm device 13, in which the computer 12 further comprises a motion determining unit 14, a chrominance variance analyzing unit 15, an edge blur analyzing unit 16, a flickering frequency analyzing unit 17, a comparing unit 18 and a database 19. The database 19 stores the enormous experimental and statistic calculated features data of the fire smoke including the thresholds of the chrominance variance, the edge blur and the flickering frequency (0.5˜5 Hz).

The smoke detecting device captures a video segment by the image capturing device 11, wherein the video segment has several objects and the background. The motion determining unit 14 determines if the objects in the video are moving by using the updating background motion detecting technique. The chrominance variance analyzing unit 15 analyzes the chrominance variance of the moving objects with their corresponding backgrounds in the video, and then the comparing unit 18 compares the analyzed results to the statistic data stored in the database 19 to determine if the analyzed data meet the chrominance variance of the background affected by the smoke. The edge blur analyzing unit 16 analyzes the blur of the edges in the video by using the space wavelet calculation, and then the comparing unit 18 compares the analyzed results to the statistic data stored in the database 19 to determine if the analyzed data meet the edge blur of the background affected by the smoke. The flickering frequency analyzing unit 17 analyzes the flickering frequency varying with time of the moving objects with their corresponding backgrounds by using the time wavelet calculation, and then the comparing unit 18 compares the analyzed results to the statistic data (0.5˜5 Hz) stored in the database 19 to determine if the analyzed data meet the flickering frequency of the moving objects with their corresponding backgrounds affected by the smoke. If the above conditions are all satisfied, the computer 12 will determine the moving objects as the fire smoke and generate an alarm signal through the alarm device 13. The alarm device 13 sends the alarm signal to the central controlling computer of the fire monitoring center, the flame signal receiver or a cellphone.

Please refer to FIG. 1B, which illustrates the structure of the flame detecting device according to a second preferred embodiment of the present invention. The flame detecting device includes an image capturing device 21, a digital video recorder 22 and an alarm device 23. The digital video recorder 22 comprises a digital signal processor 24, which contains a motion determining unit 241, a chrominance variance analyzing unit 242, an edge blur analyzing unit 243, a flickering frequency analyzing unit 244, a comparing unit 245 and a database 246. The database 246 stores the enormous experimental and statistic calculated features data of the fire smoke including the thresholds of the chrominance variance, the edge blur and the flickering frequency (0.5˜5 Hz).

The smoke detecting device captures a video segment by the image capturing device 21, wherein the video segment has several objects and the background. The motion determining unit 241 determines if the objects in the video are moving by using the updating background motion detecting technique. The chrominance variance analyzing unit 242 analyzes the chrominance variance of the moving objects with their corresponding backgrounds in the video, and then the comparing unit 245 compares the analyzed results to the statistic data stored in the database 246 to determine if the analyzed data meet the chrominance variance of the moving objects with their corresponding backgrounds affected by the smoke. The edge blur analyzing unit 243 analyzes the blur of the edges in the video by using the space wavelet calculation, and then the comparing unit 245 compares the analyzed results to the statistic data stored in the database 246 to determine if the analyzed data meet the edge blur of the background affected by the smoke. The flickering frequency analyzing unit 244 analyzes the flickering frequency varying with time of the moving objects with their corresponding backgrounds by using the time wavelet calculation, and then the comparing unit 245 compares the analyzed results to the statistic data (0.5˜5 Hz) stored in the database 246 to determine if the analyzed data meet the flickering frequency of the moving objects with their corresponding backgrounds affected by the smoke. If the above conditions are all satisfied, the digital signal processor 24 will determine the moving objects as the fire smoke and generate an alarm signal through the alarm device 23. The alarm device 23 sends the alarm signal to the central controlling computer of the fire monitoring center, the flame signal receiver or a cellphone.

Please refer to FIG. 1C, which shows the smoke detecting device according to a third preferred embodiment of the present invention. The smoke detecting device includes an image capturing device 31 and an alarm device 32. The image capturing device 31 comprises a digital signal processor 33, which contains a motion determining unit 331, a chrominance variance analyzing unit 332, an edge blur analyzing unit 333, a flickering frequency analyzing unit 334, a comparing unit 335 and a database 336. The database 336 stores the enormous experimental and statistic calculated features data of the fire smoke including the thresholds of the chrominance variance, the edge blur and the flickering frequency (0.5˜5 Hz).

The smoke detecting device captures a video segment by the image capturing device 31, wherein the video segment has several objects and the background. The motion determining unit 331 determines if the objects in the video are moving by using the updating background motion detecting technique. The chrominance variance analyzing unit 332 analyzes the chrominance variance of the moving objects with their corresponding backgrounds in the video, and then the comparing unit 335 compares the analyzed results to the statistic data stored in the database 336 to determine if the analyzed data meet the chrominance variance of the moving objects with their corresponding backgrounds affected by the smoke. The edge blur analyzing unit 333 analyzes the blur of the edges in the video by using the space wavelet calculation, and then the comparing unit 335 compares the analyzed results to the statistic data stored in the database 336 to determine if the analyzed data meet the edge blur of the background affected by the smoke. The flickering frequency analyzing unit 334 analyzes the flickering frequency varying with time of the moving objects with their corresponding backgrounds by using the time wavelet calculation, and then the comparing unit 335 compares the analyzed results to the statistic data (0.5˜5 Hz) stored in the database 336 to determine if the analyzed data meet the flickering frequency of the moving objects with their corresponding backgrounds affected by the smoke. If the above conditions are all satisfied, the digital signal processor 33 will determine the moving objects as the fire smoke and generate an alarm signal through the alarm device 32. The alarm device 32 sends the alarm signal to the central controlling computer of the fire monitoring center, the flame signal receiver or a cellphone.

The database 19, 246, 336 in the smoke detecting device of the present invention stores lots of the smoke feature data which are the smoke image analyzed data from a lot of the fire documentary films. The smoke feature data are a threshold obtained from the features analyzing and statistic calculating of the smoke in the fire documentary films, in which the chrominance variance is the analysis to the chrominance variance of the background affected by the smoke in the video by using the two-dimensional space wavelet calculation. The edge blur is the analysis to the blur of the edges of the background affected by the smoke in the video by using the two-dimensional space wavelet calculation. The flickering frequency is the analysis to the brightness varying with time of the smoke in the video by using the one-dimensional time wavelet calculation.

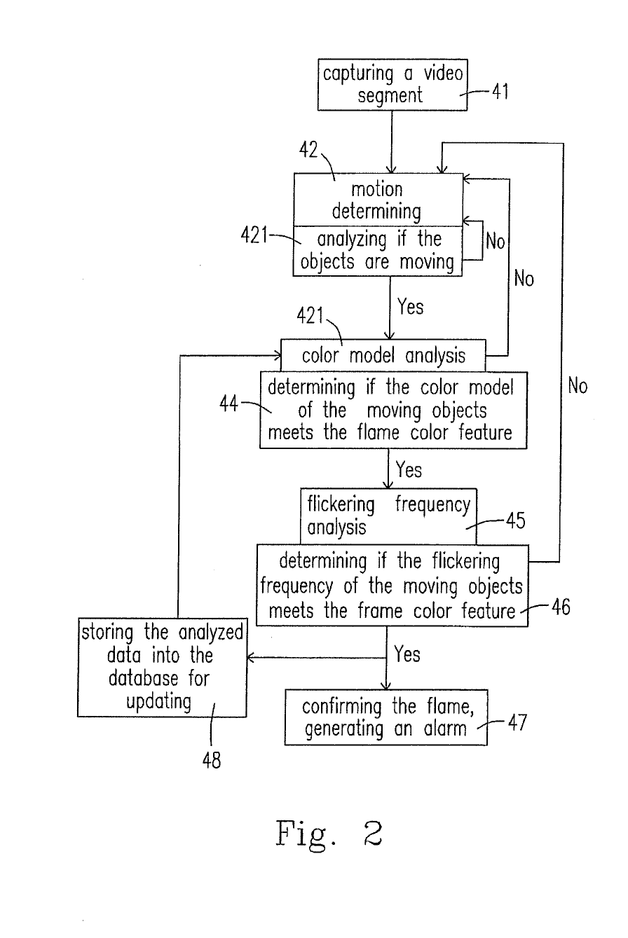

Please refer to FIG. 2, which shows the flow chart of the smoke detecting method in the present invention. Firstly, the video segment is captured (step 41). Then, the motion of the object is determined and the chrominance variance of the background is analyzed (step 42). Whether the object is moving and whether the chrominance variance of the background is turned into gray are determined (step 43). If the object is moving and the chrominance variance of the moving objects with their corresponding backgrounds are turned into gray, the flow proceeds to step 44; if not, the flow goes back to step 42. Next, the flickering frequency of the moving objects with their corresponding backgrounds in the video and the edge blur of the background therein are analyzed (step 44). Subsequently, whether the smoke exists is determined (step 45). In step 45, if the flickering frequency of the moving objects with their corresponding backgrounds and the edge blur of the background both meet the smoke features, which indicates that the smoke exists, the flow proceeds to step 46; if not, which indicates that the smoke does not exists, the flow goes back to step 42 If the smoke exists, an alarm signal is generated (step 46).

Accordingly, the smoke detecting method and device of the present invention can precisely determine whether the smoke exists for detecting and alarming the fire at the early stage, so that the fire may be put out in time and the disaster may be reduced. Furthermore, the present invention is set by using the original network system and monitoring devices, which achieves a better smoke detecting effect without extra expensive construction or facilities.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present application which is defined by the appended claims.

What is claimed is:

1. A smoke detecting method, comprising steps of:
(a) capturing a video segment for an object and a background;
(b) analyzing if an image of the object is moving;
(c) analyzing a chrominance variance of the moving object with its corresponding background;
(d) analyzing at least one of an edge blur of the image of the background and a flickering frequency of the image of the moving object with its corresponding background;
(e) comparing analyzed results obtained from the steps (b)-(d) to a smoke feature; and
(f) determining if the moving object is a smoke.

2. A smoke detecting method as claimed in claim 1, further comprising:
(g) sending out an alarm when the moving object is determined as the smoke.

3. A smoke detecting device, comprising:
an image capturing device capturing a video segment having a first image for an object and a second image for a background;
a determining device coupled to the image capturing device, analyzing if the first image is moving, analyzing a chrominance variance of the first and the second images and at least one of an edge blur of the second image and a flickering frequency of the first and the second images; and
determining if the object is a smoke by comparing analyzed results of the first and the second images to a smoke feature.

4. A smoke detecting device according to claim 3 further comprising an alarming device coupled to the determining device for generating an alarm when the object is determined as the smoke.

5. A smoke detecting device according to claim 3, wherein the image capturing device is one of a web camera and a cable camera.

6. A smoke detecting device according to claim 3, wherein the determining device is one of a computer and a digital signal processing chip.

7. A smoke detecting device according to claim 3, wherein the chrominance variance is a chrominance-decreased extent affected by the smoke.

8. A smoke detecting device according to claim 3, wherein the edge blur reflects how an edge of the background is affected by the smoke.

9. A smoke detecting device, comprising:
an image capturing device capturing a first image for an object and a second image for a background;
a first analyzing device coupled to the image capturing device and analyzing at least one of a flickering frequency of the first and the second images and an edge blur of the second image; and
a comparing device coupled to the first analyzing device and comparing a first analyzed result obtained from the first analyzing device to a smoke feature.

10. A smoke detecting device according to claim 9 further comprising:
a second analyzing device coupled to the image capturing device and analyzing if the first image is moving; and
a third analyzing device coupled to the image capturing device and analyzing a chrominance variance of the first and the second images, wherein the comparing device is further coupled to the image capturing device and compares the first analyzed result obtained from the first analyzing device and second analyzed results obtained from the second and the third analyzing devices to the smoke feature.

11. A smoke detecting device according to claim 10 further comprising an alarming device coupled to the comparing device and generating an alarm when a comparison of the analyzed results to the smoke feature shows that the object is a smoke.

12. A smoke detecting device according to claim 9 further comprising an alarming device coupled to the comparing device and generating an alarm when a comparison of the first analyzed result to the smoke feature shows that the object is a smoke.

13. A smoke detecting device according to claim 9, wherein the image capturing device is one of a web camera and a cable camera.

14. A smoke detecting device according to claim 9, wherein the first analyzing device is one of a computer and a digital signal processing chip.

15. A smoke detecting device according to claim 9, wherein each of the second and third analyzing devices is one of a computer and a digital signal processing chip.

16. A smoke detecting device according to claim 9, wherein the chrominance variance is a chrominance-decreased extent of the second image affected by the smoke.

17. A smoke detecting device according to claim 9, wherein the flickering frequency is a brightness variation of the first image varying with time.

18. A smoke detecting device according to claim 16, wherein the edge blur of the second image is affected by the smoke.
